(19) United States
(12) Patent Application Publication
(10) Pub. No.: US 2022/0028360 A1
(43) Pub. Date: Jan. 27, 2022

(54) METHOD, COMPUTER PROGRAM AND APPARATUS FOR GENERATING AN IMAGE

(71) Applicant: Vestel Elektronik Sanayi ve Ticaret A.S., Manisa (TR)

(72) Inventor: Özkan ÖZDEMÍR, Manisa (TR)

(21) Appl. No.: 17/293,430

(22) PCT Filed: Nov. 14, 2018
(86) PCT No.: PCT/EP2018/081205

§ 371 Date: May 12, 2021

(51) Int. Cl. G09G 5/397

(52) U.S. Cl. CPC G09G 5/397; G09G 2360/18; G09G 2340/125; G09G 2340/10

(57) ABSTRACT

Background image data is written to a background buffer of memory. Foreground image data is written to a foreground buffer of memory. A visual effect is applied to at least one of the background image and the foreground image by modifying the background image data and/or the foreground image data respectively. The data is merged in a screen buffer of memory. The image for display is generated by reading the merged data in the screen buffer.

### TECHNICAL FIELD

The present disclosure relates to a method, computer program and apparatus for generating an image.

### BACKGROUND

Many electronic devices have relatively sophisticated operating systems which manage the device hardware and software resources and provide common services for computer programs running on the device. Many electronic devices also have relatively large amounts of “working” memory which is used by the operating system and computer programs running on the device. This enables sophisticated control of the device and also enables sophisticated user interfaces and visual effects to be provided on a display screen or the like.

However, there are many devices that only have relatively low processing power and a very simple operating system and/or small amounts of working memory. Such devices cannot allow visual effects to be applied to a display image, or at least not in an efficient manner.

### SUMMARY

According to a first aspect disclosed herein, there is provided a method of generating an image for display on a display screen, the method comprising:

writing background image data to a background buffer of memory;

writing foreground image data to a foreground buffer of memory;

applying a visual effect to at least one of the background image and the foreground image by modifying the background image data and/or the foreground image data respectively;

merging, in a screen buffer of memory, the foreground image data and the background image data, where the image data for an image that is merged in the screen buffer is the modified image data in the case that the image data was modified; and

generating the image for display by reading the merged data in the screen buffer.

That is, the image data that is merged in the screen buffer is the modified foreground image data if a visual effect is applied to a foreground image, or modified background image data if a visual effect is applied to a background image, or both if both are modified, and that is merged with unmodified image data for any part of the image that is not modified.

In an example, the visual effect is applied to an image by modifying the image data for that image as the image data for that image is written to the screen buffer. As an alternative, the visual effect may be applied by modifying the data in the relevant foreground or background buffer prior to writing that modified data to the screen buffer.

Typically, the image which is generated fills the display screen.

In an example, the method comprises:

locking the screen buffer prior to writing data from the foreground buffer and the background buffer to the screen buffer; and

unlocking the screen buffer after the merging of the data in the screen buffer so as to enable the merged data to be read to generate the image for display.

This ensures that the display screen is only updated with the image that is produced by merging the foreground and background data after the merging has been completed. This helps to avoid flickering or other unwanted artefacts in the image that is actually being displayed on the display screen at any particular time.

In an example, the method comprises:

repeating the applying a visual effect to at least one of the background image and the foreground image, the merging in the a screen buffer, and the generating the image for display by reading the merged data in the screen buffer in the case that the visual effect is or comprises an animation effect.

In an example, the method comprises:

allocating a first region of the memory as the background buffer prior to writing background image data to the background buffer;

allocating a second region of the memory as the foreground buffer prior to writing foreground image data to the foreground buffer; and

releasing the first and second regions of memory after the data in the foreground buffer has been merged with the data in the background buffer.

This frees up the memory that was allocated for the foreground and background buffers for use for other purposes. The memory is effectively only allocated for the foreground and background buffers when needed to allow a visual effect to be applied to the image.

In an example, the merging the data in the screen buffer comprises alpha compositing the foreground image data and the background image data.

In an example, the method comprises:

writing image data to one or more intermediate buffers of memory, said image data being data for one or more intermediate images that are intermediate the foreground and background, and the merging comprises merging the foreground image data with the background image data and the intermediate image data.

In an example, the method comprises:

applying a visual effect to an intermediate image by modifying the intermediate image data prior to the merging.

According to a second aspect disclosed herein, there is provided a computer program comprising instructions such that when the computer program is executed on a computing device, the computing device is arranged to carry out a method of generating an image for display on a display screen, the method comprising:

writing background image data to a background buffer of memory;

writing foreground image data to a foreground buffer of memory;

applying a visual effect to at least one of the background image and the foreground image by modifying the background image data and/or the foreground image data respectively;

merging, in a screen buffer of memory, the foreground image data and the background image data, where the image data for an image that is merged in the screen buffer is the modified image data in the case that the image data was modified; and

generating the image for display by reading the merged data in the screen buffer.

There may be provided a non-transitory computer-readable storage medium storing a computer program as described above.

According to a third aspect disclosed herein, there is provided for generating an image for display on a display screen, the apparatus comprising:

a processor and memory,

the processor being constructed and arranged to:

write background image data to a background buffer of memory;

write foreground image data to a foreground buffer of memory;

apply a visual effect to at least one of the background image and the foreground image by modifying the background image data and/or the foreground image data respectively;

merge, in a screen buffer of memory, the foreground image data and the background image data, where the image data for an image that is merged in the screen buffer is the modified image data in the case that the image data was modified; and

generate the image for display by reading the merged data in the screen buffer.

### BRIEF DESCRIPTION OF THE DRAWINGS

To assist understanding of the present disclosure and to show how embodiments may be put into effect, reference is made by way of example to the accompanying drawings in which:

FIG. 1 shows schematically examples of devices according to an embodiment of the present disclosure;

FIG. 2 shows schematically a portion of a volatile memory according to an embodiment of the present disclosure;

FIG. 3 shows schematically a screen buffer when a visual effect is applied to a foreground image according to an embodiment of the present disclosure;

FIG. 4 shows schematically a screen buffer when a visual effect is applied to a background image according to an embodiment of the present disclosure;

FIG. 5 shows schematically a screen buffer when a visual effect is applied to a foreground image and a background image according to an embodiment of the present disclosure; and

FIGS. 6 to 11 show schematically background, foreground and screen buffers when applying visual effects and an animation according to an embodiment of the present disclosure.

### DETAILED DESCRIPTION

As noted, many electronic devices have relatively sophisticated operating systems and relatively large amounts of “working” memory which is used by the operating system and computer programs running on the device. This enables sophisticated control of the device and also enables sophisticated user interfaces and visual effects to be provided on a display screen or the like.

As a particular example which is familiar to most users of computers and “smart” phones and the like, many operating systems make use of or implement a graphical user interface that has a “window” structure, in which the windows are graphical control elements. Each window consists of a visual area containing some of the graphical user interface of the program to which it belongs and is typically framed by a window border or decoration. Each window typically has a rectangular shape, which that can overlap with the area of other windows. Each window typically displays the output of and may allow input to one or more processes. The windows can usually be manipulated with a pointer by employing some kind of pointing device or by touch on a touch screen, etc. The operating system provides separate off-screen memory portions for each window, and the contents of the windows memory portions are composited in order to generate the display image that is presented on a display screen at any particular point in time. Each memory portion for each window is effectively independent of the others, such that each window can be manipulated (such as moved over the display screen or have visual effects applied) independently of the other windows.

However, this places high demands on the operating system, which therefore requires a sophisticated operating system and a relatively powerful and therefore expensive CPU or central processing unit, which increases costs. This also requires a large amount of memory to be provided, again increasing costs.

As a result, there are many devices that have relatively low processing power and therefore only a very simple operating system and/or small amounts of working memory. This includes devices whose primary purpose may not be computing as such. Some examples include television sets, set-top boxes and PVRs (personal video recorders, also known as a DVR or digital video recorder). The operating systems of such devices do not have a windows type graphical user interface or display in which each window has a separate and independent memory portion. Accordingly, such known devices cannot allow visual effects to be applied to a display image, or at least not in an efficient manner.

According to examples of the present disclosure, there is provided a method, a computer program and apparatus for generating an image for display on a display screen. Background image data is written to a background buffer of memory. Foreground image data is written to a foreground buffer of memory. A visual effect is applied to at least one of the background image and the foreground image by modifying the background image data and/or the foreground image data. The data may be modified as it is written to a screen buffer or whilst it is in the foreground or background buffer as the case may be and prior to writing it to the screen buffer. The modified and any unmodified data are merged in the screen buffer of memory. The image for display is generated by reading the merged data from the screen buffer.

This enables visual effects to be applied to one or both of the background and the foreground of an image in an efficient way. The method can be applied in devices that do not have a windows type graphical user interface or display in which each window has a separate and independent portion in memory. In particular, the method can be applied in devices in which data for a whole frame or screen of an image is stored as a block or a unit (as a single layer or window) and read as a block or a unit when data for a frame or screen of an image is sent to a display screen for display. Visual effects can be applied to one or both of the background and the foreground of an image (and optionally to further intermediate layers of the image) without requiring the whole of the frame or screen of the image to be redrawn or calculated for storage in the screen buffer. This makes it possible to apply visual effects, which otherwise are not normally supported in known devices that have a single layer graphics system. Such visual effects include for example transition effects or animations, such as for example fading, sliding, pixelate, scaling, grey scale, blur, diffusion, etc, as well as adjustments to colour, brightness and contrast generally.

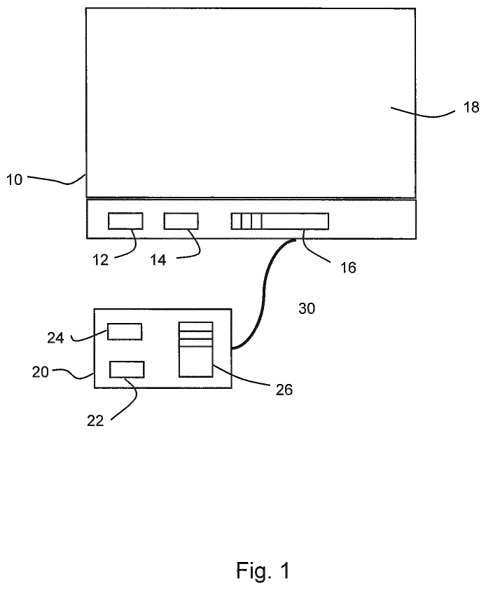

Referring now to FIG. 1, this shows schematically examples of devices according to an embodiment of the present disclosure and which are enabled to carry out an example of a method according to an embodiment of the present disclosure. FIG. 1 shows schematically a television set 10 and a set-top box 20, either or both of which is a device according to according to an embodiment of the present disclosure and is capable of carrying out a method according to an embodiment of the present disclosure. The television set 10 and the set-top box 20 may be arranged to receive broadcast, multicast or unicast television signals, via for example terrestrial, satellite, cable or internet. The television set 10 and the set-top box 20 are connected by a cable connection 30 so that the set-top box 20 can send audio and video signals to the television set 10. The television set 10 may additionally or alternatively be connected to receive audio and video from other devices, such as a DVD or Blu Ray player, a PVR, etc.

The television set 10 has one or more processors 12, permanent (non-volatile) data storage 14 and working or volatile memory 16 as usual. The one or more processors 12 are configured to run one or more computer programs for operation of the television set 10. The volatile memory 16 is notionally or logically divided into separate portions or buffers, at least temporarily, as discussed further below. The television set 10 also has a display screen 18 for displaying images.

The set-top box 20 similarly has one or more processors 22, permanent (non-volatile) data storage 24 and working or volatile memory 26 as usual. The one or more processors 22 are configured to run one or more computer programs for operation of the set-top box 20. The volatile memory 26 is notionally or logically divided into separate portions or buffers, at least temporarily, as discussed further below.

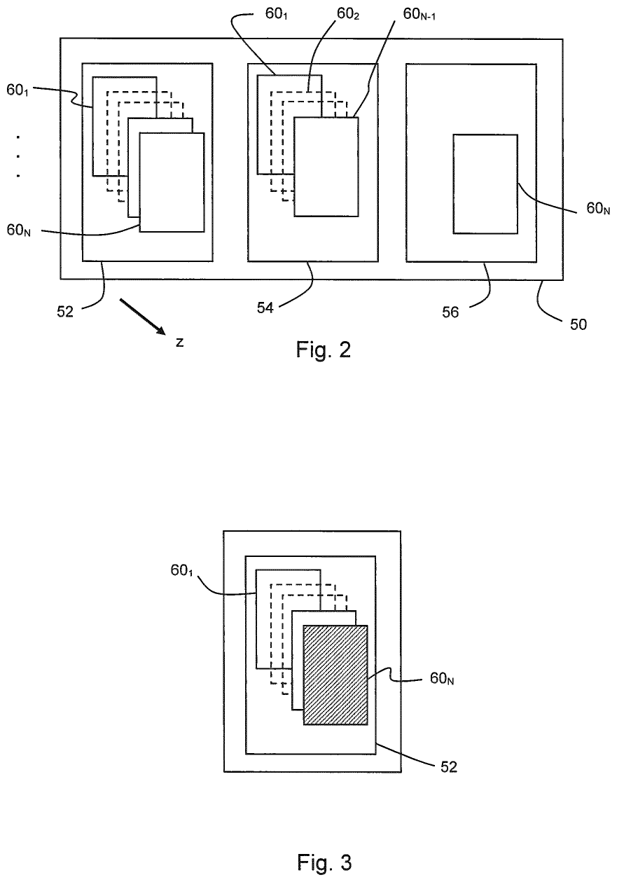

Referring now to FIG. 2, this shows schematically a portion of a volatile memory 50. The volatile memory 50 is provided in a device according to an example of the present disclosure, such as a television set 10, a set-top box 20 or some other device and data is written to and read from the volatile memory under control of a processor of the device. Images for display on display screen are generated and stored (temporarily) in the volatile memory. The display screen may be part of the device or may be a separate display screen.

As mentioned, in known television sets, set-top boxes or other devices for generating an image for display on a television screen or the like, the device typically runs a simple operating system which does not have windows management or the like for images that are to be displayed. Any applications running on the device and that are generating images for display draw the entire image that is to be displayed for the whole screen at any particular instant in time to some volatile memory. The entire image is then read from the volatile memory to the display screen to be displayed. This means that if for example one part of the image changes, because for example one section or “window” within the entire image changes, such as changes colour or brightness or moves across the screen, then the whole image has to be rewritten to the volatile memory and then read again to the display screen to be displayed. If the image is formed of several sections or windows, then each of these has to be written in turn to the volatile memory in order to generate the next entire image that is to be displayed on the display screen. This is efficient in terms of memory usage, meaning that only a small amount of memory has to be provided for the image. However, it means that applying effects or animations in real time is practically impossible because the repeated draw functions to redraw each section or window take too long and can effectively tie up the main processor, meaning that the displayed image can flicker and that the whole device may run slowly.

In contrast and referring again to FIG. 2, in examples described herein, the volatile memory 50 is (notionally or logically) structured so as to provide at least three display buffers for storing images, at least temporarily when required. In particular, the memory 50 has a screen buffer 52, a background buffer 54 and a foreground buffer 56. The final image, which is constructed as discussed further below, is stored in the screen buffer 52 and is read from there to cause the final image to be displayed on a display screen. The background buffer 54 is used to store temporarily background image data. The foreground buffer 56 is used to store temporarily foreground image data. The background buffer 54 and the foreground buffer 56 only need to be allocated and used if and when a visual effect is to be applied to the image. Otherwise, if no visual effects are to be applied as described herein, only the screen buffer 52 needs to be used for storing the image prior to display, as in known television sets and similar devices.

In this regard, it is mentioned that when reference is made to storing an image in a memory and reading an image from a memory or the like, this is a reference to storing and reading the data that is necessary to allow the image to be displayed. Such data identifies for example the colour and brightness of each pixel, the alpha of each pixel and the location of each pixel on the display screen. With regard to the “alpha” of a pixel, in a 2D image element, which stores a colour for each pixel, additional data is stored in the alpha channel with a value between 0 and 1. A value of 0 means that the pixel is transparent. A value of 1 means that the pixel is opaque. A value between 0 and 1 represents the degree or relative amount of transparency or opacity.

Returning to FIG. 2, there is shown stored in the screen buffer 52 a number of layers 60₁ to 60_{N} of image data. There are at least two layers of image data, which represent background image data and foreground image data. There may be further, intermediate layers of image data, some of which are shown schematically with dashed lines in the drawing. The layers 60₁ to 60_{N} of image data are combined or merged in the screen buffer 52 to produce the final image, which can then be sent to the display screen to be displayed. The layer with the lowest index, namely layer 60₁, is the most rearwards of the image layers. The layer with the highest index, namely layer 60_{N} in this example, is the most forwards of the image layers. This is indicated by the z direction in FIG. 2, which goes from the rear of the display screen to the front of the display screen, i.e. towards the viewer.

The background buffer 54 and the foreground buffer 56 are allocated in the volatile memory 50 when a visual effect is to be applied to the image. The visual effect is applied to the image data in one or both of the background buffer 54 and the foreground buffer 56 as desired, depending on for example the precise effect that is to be applied or achieved. The image data from the background buffer 54 and the foreground buffer 56 is then written to the screen buffer 52, where it is then merged to generate the final image which is then sent to the display screen for display. Alternatively or additionally, the visual effect may be applied to the image data from one or both of the background buffer 54 and the foreground buffer 56 as that image data is written to the screen buffer 52. Either way, the image data that is now in the screen buffer 52 is image data to which the desired visual effect has been applied. The background buffer 54 and the foreground buffer 56 can then be released, i.e. no longer reserved for storing image data, if desired, which frees up space in the volatile memory 50 for use by applications running generally on the device.

With this arrangement, it becomes possibly to apply three broad types of visual effect to the image to be displayed. The specific visual effect, which in general may be applied to the foreground or the background, may in general be any visual effect. Examples include fading, sliding, pixelate, scaling, grey scale, blur, diffusion, etc, as well as adjustments to colour, brightness and contrast generally.

A first example is a foreground visual effect. For this, background image data for the image is written to the background buffer 54. This is indicated in FIG. 2 by at least the first background layer 60₁ which is stored in the background buffer 54. In this example, one or more further background layers 60₂ . . . 60_{N-1} are also stored in the background buffer 54. In addition, foreground image data for the image is written to the foreground buffer 56. This is indicated in FIG. 2 by the foreground layer 60_{N}. The desired visual effect is then applied to the foreground image data 60_{N} in the foreground buffer 56. The image data in the background buffer 54 is copied or moved to the screen buffer 52. The image data in the foreground buffer 56 is also copied or moved to the screen buffer 52. In this case, the image data in the foreground buffer 56 that is copied or moved to the screen buffer 52 is the modified data which is produced as a result of applying the visual effect to the foreground image data 60_{N} in the foreground buffer 56. As mentioned, as an alternative, the visual effect may be applied as the image data in the foreground buffer 56 is copied or moved to the screen buffer 52. Either way, the image data now in the screen buffer 52 is image data to which the desired visual effect has been applied (here, to the foreground image). The background buffer 54 and the foreground buffer 56 can then be released, i.e. no longer reserved for storing image data, if desired, which frees up space in the volatile memory 50 for use by applications running generally on the device.

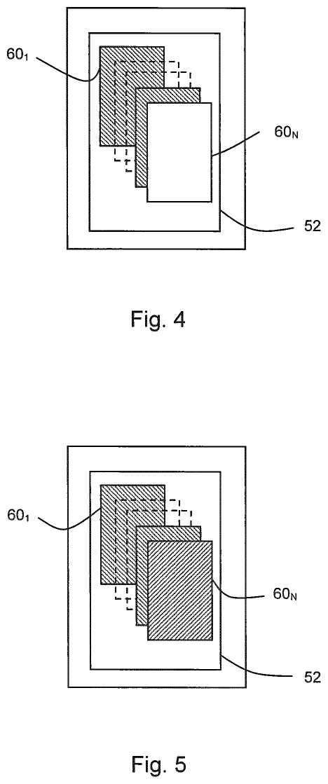

This is shown schematically in FIG. 3. This shows the screen buffer 52 when a visual effect is applied to a foreground image. The or each background layer 60₁ . . . 60_{N-1} has been copied or moved from the background buffer 54. The foreground layer 60_{N} has been copied or moved from the foreground buffer 56. As mentioned, the foreground layer 60_{N} is modified data as a visual effect has been applied to the foreground image data in the foreground buffer 56 or as the foreground image data was copied or moved to the screen buffer 52. This is indicated by shading of the foreground layer 60_{N} in FIG. 3.

The background image data and the foreground image data in the screen buffer 52 are effectively merged. That is, the final image, which is to be displayed on the display screen, is formed by processing the background image data and the foreground image data in the screen buffer 52 pixel by pixel in the z-order of the image data, starting at the back of the image and moving forwards (towards the viewer). For example, at a particular pixel that is being processed in the screen buffer 52, if the target pixel in the foreground image or layer 60_{N} is transparent (the pixel has an alpha level of 0), then the colour and brightness of the corresponding background pixel is used for that pixel in the final image to be displayed. If the target pixel of the foreground image or layer 60_{N} is opaque (the pixel has an alpha level of 1), then the colour and brightness of that pixel of the foreground image or layer 60_{N} is used directly. If the target pixel of the foreground image or layer 60_{N} has an alpha level that is between 0 and 1, then the colours and brightness of the background and foreground pixels are blended or mixed according to the value of the alpha level, or according to the ratio of the alpha levels if there are one or more intermediate layers. 60₂ . . . 60_{N-1}. This operation is carried out for all pixels in the image layers.

During this process, when the background and foreground image data are being transferred to and merged in the screen buffer 52, the screen buffer 52 is locked, under control of for example the processor of the device in accordance with example a graphics display device driver. This locking of the screen buffer 52 ensures that image data is not sent from the screen buffer 52 to the display screen whilst the contents of the background buffer 54 and the foreground buffer 56 are being moved or copied to the screen buffer 52 and are being merged in the screen buffer 52. This prevents screen flicker or other undesirable effects being caused to the image that is currently being displayed by the display screen.

Once the merger of the background and foreground image data is complete, the data remaining in the screen buffer 52 represents the final image to be displayed on the display screen. The screen buffer 52 is unlocked or released, again under control of for example the processor of the device. This causes the display screen to be updated with the final image which is therefore displayed on the display screen.

In the case that the desired visual effect is some animation, that is a moving or changing effect, this is repeated for subsequent frames of the image. For each frame, the foreground image data in or from the foreground buffer 56 is adjusted and the adjusted foreground image data is merged with the background image data in the screen buffer 52. The final image to be presented on the display screen is sent to the display screen as necessary and this is repeated frame by frame as necessary to enable the animation effect to appear on the display screen. Again, the background buffer 54 and the foreground buffer 56 can be released once the entire animation sequence is complete to free up space in the volatile memory 50 for use by applications running generally on the device.

A second example is a background visual effect. For this, background image data for the image is written to the background buffer 54. Again, this is indicated in FIG. 2 by at least the first background layer 60₁ which is stored in the background buffer 54. In this example, one or more further background layers 60₂ . . . 60_{N-1} are also stored in the background buffer 54. In addition, again, foreground image data for the image is written to the foreground buffer 56. This is indicated in FIG. 2 by the foreground layer 60_{N}. The desired visual effect is then applied to the background image data in the background buffer 54. If there is more than one background layer in the background buffer, the visual effect may be applied to one or several or all of the background image layers 60₁ . . . 60_{N-1}, depending on for example the effect that is to be achieved. The image data in the background buffer 54 is copied or moved to the screen buffer 52. In this case, the image data in the background buffer 54 that is copied or moved to the screen buffer 52 is the modified data which is produced as a result of applying the visual effect to the background image data in the background buffer 54. As mentioned, as an alternative, the visual effect may be applied as the image data in the background buffer 54 is copied or moved to the screen buffer 52. Either way, the background image data now in the screen buffer 52 is background image data to which the desired visual effect has been. The image data in the foreground buffer 56 is also copied or moved to the screen buffer 52. The background buffer 54 and the foreground buffer 56 can then be released, i.e. no longer reserved for storing image data, if desired, which frees up space in the volatile memory 50 for use by applications running generally on the device.

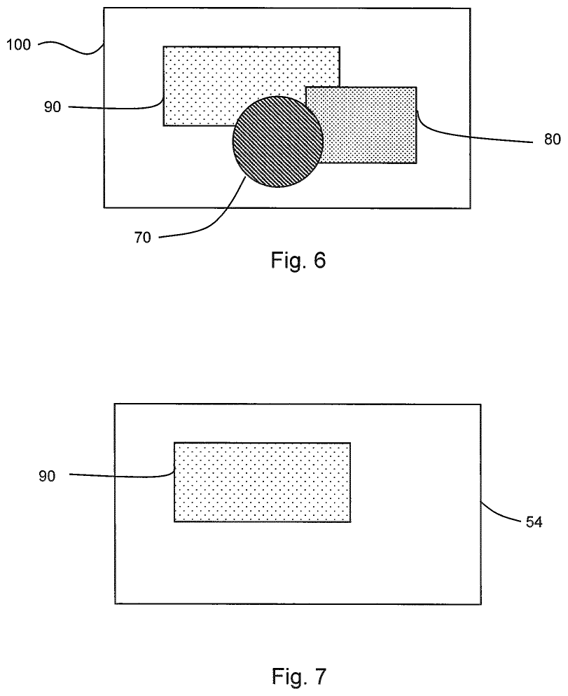

This is shown schematically in FIG. 4. This shows the screen buffer 52 when a visual effect is applied to a background image. The foreground layer 60_{N} has been copied or moved from the foreground buffer 56. The or each background layer 60₁ . . . 60_{N-1} has been copied or moved from the background buffer 54. As mentioned, in this case there are plural background image layers 60₁ . . .60_{N-1} and one or more of the background image layers 60₁ . . . 60_{N-1} is modified data as a visual effect was applied to the background image data in the background buffer 54 or as the background image data was copied or moved to the screen buffer 52. This is indicated by shading of (some of) the background image layers 60₁ . . . 60_{N-1} in FIG. 4.

The background image data and the foreground image data in the screen buffer 52 are effectively merged. That is, the final image, which is to be displayed on the display screen, is formed by processing the background image data and the foreground image data in the screen buffer 52 pixel by pixel in the z-order of the image data, starting at the back of the image and moving forwards (towards the viewer), as discussed above.

During this process, when the background and foreground image data are being transferred to and merged in the screen buffer 52, the screen buffer 52 is again locked, under control of for example the processor of the device in accordance with example a graphics display device driver. Once the merger of the background and foreground image data is complete, the data remaining in the screen buffer 52 represents the final image to be displayed on the display screen. The screen buffer 52 is unlocked or released, again under control of for example the processor of the device. This causes the display screen to be updated with the final image which is therefore displayed on the display screen.

In the case that the desired visual effect is some animation, that is a moving or changing effect, again this is repeated for subsequent frames of the image.

A third example is a background and a foreground visual effect. The same or different specific visual effect may be applied to one or more background layers and the foreground layer. For this, background image data for the image is written to the background buffer 54. Again, this is indicated in FIG. 2 by at least the first background layer 60₁ and optionally one or more further background layers 60₂ . . . 60_{N-1} which are stored in the background buffer 54. The desired visual effect for the or each background layer 60₁ to 60_{N-1} is then applied to the background image data in the background buffer 54 as necessary. In addition, foreground image data for the image is written to the foreground buffer 56. Again, this is indicated in FIG. 2 by the foreground layer 60_{N}. The desired visual effect for the foreground image is applied to the foreground image data 60_{N} in the foreground buffer 56. The image data in the background buffer 54 is copied or moved to the screen buffer 52. The image data in the foreground buffer 56 is also copied or moved to the screen buffer 52. In each case, this is the modified data which is produced as a result of applying the visual effect to the background image data and the foreground image data respectively. Again, as an alternative for one or both of the foreground image and background image, the visual effect may be applied as the image data in the is copied or moved to the screen buffer 52. Either way, the image data now in the screen buffer 52 is image data to which the desired visual effect has been applied (here, to the foreground and one or more background image). The background buffer 54 and the foreground buffer 56 can then be released, i.e. no longer reserved for storing image data, if desired, which frees up space in the volatile memory 50 for use by applications running generally on the device.

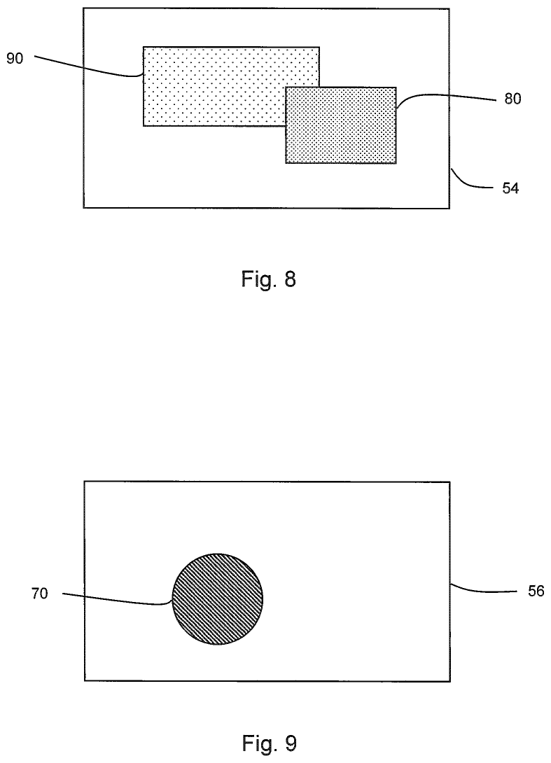

This is shown schematically in FIG. 5. This shows the screen buffer 52 when a visual effect is applied to a background image and a foreground image. The foreground layer 60_{N} has been copied or moved from the foreground buffer 56. The or each background layer 60₁ . . . 60_{N-1} has been copied or moved from the background buffer 54. As mentioned, in this case there are plural background image layers 60₁ . . . 60_{N-1} and one or more of the background image layers 60₁ . . . 60_{N-1} is modified data as a visual effect was applied to the background image data in the background buffer 54. Also, the foreground layer 60_{N} is modified data as a visual effect was applied to the foreground image data in the foreground buffer 56. This is indicated by shading of (some of) the background image layers 60₁ . . . 60_{N-1} and the foreground layer 60_{N} in FIG. 5.

The background image data and the foreground image data in the screen buffer 52 are effectively merged. That is, the final image, which is to be displayed on the display screen, is formed by processing the background image data and the foreground image data in the screen buffer 52 pixel by pixel in the z-order of the image data, starting at the back of the image and moving forwards (towards the viewer), as discussed above.

During this process, when the background and foreground image data are being transferred to and merged in the screen buffer 52, the screen buffer 52 is again locked, under control of for example the processor of the device in accordance with example a graphics display device driver. Once the merger of the background and foreground image data is complete, the data remaining in the screen buffer 52 represents the final image to be displayed on the display screen. The screen buffer 52 is unlocked or released, again under control of for example the processor of the device. This causes the display screen to be updated with the final image which is therefore displayed on the display screen.

In the case that the desired visual effect is some animation, that is a moving or changing effect, again this is repeated for subsequent frames of the image.

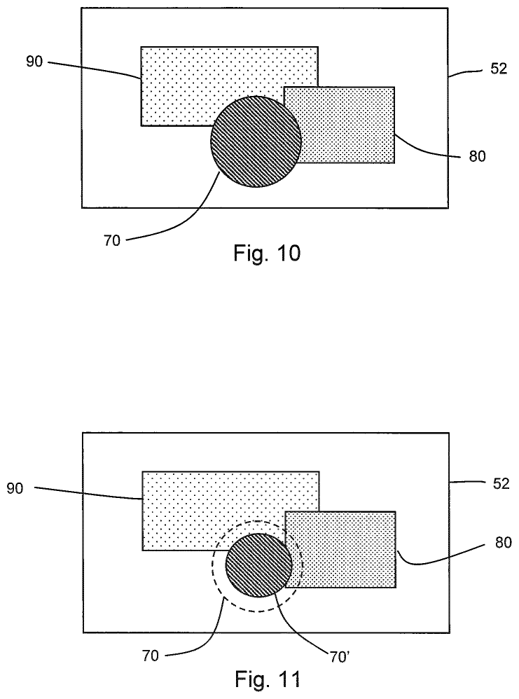

To illustrate this further, reference is made to FIGS. 6 to 11. FIG. 6 shows schematically three windows 70, 80, 90 to be displayed on a display screen 100. Window 70 is a circle window, which may be a specific colour such as for example green, and is a top (foremost) window. Window 80 is a square window, which may be a specific colour such as for example blue, and is behind window 70. Window 90 is a rectangular window, which may be a specific colour such as for example red, and is behind window 80 and in this example is the back (rearmost window).

In order to draw a screen like that shown in FIG. 6, first, the screen buffer 52 is locked to prevent unwanted effects, such as flickering, occurring on the display screen 100 whilst the screen buffer is being updated. Also, two memory areas from system resources, such as volatile memory of the device, are allocated as a background buffer 54 and a foreground buffer 56 respectively.

Then the draw function for the rearmost window, here window 90, is called to write the data for window 90 to the background buffer 54. The calling order for the draw functions for the windows should be in the same order as the z-order of the windows, so the rearmost window's draw function is called first. After the draw function for the rearmost window 90 has been called, the background buffer 54 will be as shown schematically in FIG. 7.

Then the draw function for the next window is called. In this case, this is the intermediate window 80. Accordingly, the draw function for window 80 sends it to the background buffer 54. In this case, the background buffer 54 will be as shown schematically in FIG. 8.

Next, the draw function for the foremost window, here window 70, is called to write the data for window 70 to the foreground buffer 56. After the draw function for the foremost window 70 has been called, the foreground buffer 56 will be as shown schematically in FIG. 9.

At this point, the background buffer 54 and the foreground buffer 56 are ready to have effects applied. The screen buffer 52 is locked to prevent flickering or the like in the display screen 100. If an effect is to be applied to one or both of the rear windows 80, 90, the background buffer 54 is copied to the screen buffer 52 and the changes necessary for the desired visual effect are made to the data. Likewise, if an effect is to be applied to the front window 70, the foreground buffer 56 is copied to the screen buffer 52 and the changes necessary for the desired visual effect are made to the data. Otherwise, if no effect is to be applied to a window, the data is simply copied from the background buffer 54 or the foreground buffer 56, as the case may be, to the screen buffer 52. The data in the screen buffer for the various windows is merged in the z order, as discussed above and known per se.

The result of this is shown schematically in FIG. 10, which shows the screen buffer 52 containing the merged data for the three windows 70, 80, 90. The screen buffer 52 is unlocked to allow the merged data to be written to the display screen 100 of the device concerned.

Suppose now that an animation effect is desired. By way of example, suppose that it is desired to shrink the size of the front window 70. This may proceed as follows.

First, the process may wait for a period of time which is related to the interval of time required for the animation effect. For example, the animation may be fast, requiring a short interval of time (possibly as fast as the refresh rate of the display screen 100). On the other hand, the animation may be slow, and may be seconds or more.

In any event, after that period of time has passed, the screen buffer 52 is locked. The content (rearmost windows 80, 90) of the background buffer 54 is copied to the screen buffer 52. The desired animation (here, shrinking the size) is applied to the foreground window 70 using the foreground buffer 56 and that adjusted foreground window 70′ is merged with the background image data in the screen buffer 52.

The result of this is shown schematically in FIG. 11, which shows the screen buffer 52 containing the merged data for the three windows 70′, 80, 90, with foreground window 70′ being the adjusted data for the (smaller) foreground window 70′. The screen buffer 52 is unlocked to allow the merged data to be written to the display screen 100 of the device concerned.

This may be repeated for further animation effects. In addition, further effects may be applied to the foreground window and the same or other effects may be applied to the other windows, here the rear windows 80, 90 in this example. For example, such rear windows 80, 90 may be moved and any of the windows 70, 80, 90 may be recoloured, brightened, dimmed, blurred, etc.

Examples described herein enable visual effects to be applied in an efficient manner to images that are to be displayed. The visual effects can be applied in a system that does not have a window type structure provided by its operating system and in which, in contrast, data for a whole frame or screen of an image is stored as a unit (as a single composite layer or window) and read as a unit when data for a frame or screen of an image is sent to a display screen for display.

The above can be extended. For example, if there is sufficient space in the memory 50, one or more further temporary buffers may be created for storing one or more intermediate layers of the image which are between the foreground and background image layers. Visual effects can be applied independently to the one or more intermediate layers, which enables for example more sophisticated visual effects to be applied.

As mentioned, the specific visual effect that is applied to one or both of foreground and background may be for example one or more of fading, sliding, pixelate, scaling, grey scale, blur, diffusion, etc, as well as adjustments to colour, brightness and contrast generally. The precise nature of the specific visual effect that is applied determines how the data for the individual pixels is adjusted or changed. As one example, in a fading effect, the image data of say a foreground image or window is adjusted to increase the transparency of the relevant pixels so that pixels of the background become visible “through” the foreground image. Other techniques for applying different visual effects will be well known to the person skilled in the art.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to memory and storage for storing data. This may be provided by a single device or by plural devices. Suitable devices include for example volatile semiconductor memory (e.g. RAM, including for example DRAM), non-volatile semiconductor memory (including for example a solid-state drive or SSD), a hard disk, etc.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A method of generating an image for display on a display screen, the method comprising:
writing background image data to a background buffer of memory;
writing foreground image data to a foreground buffer of memory;
applying a visual effect to at least one of the background image and the foreground image by modifying the background image data and/or the foreground image data respectively;
merging, in a screen buffer of memory, the foreground image data and the background image data, where the image data for an image that is merged in the screen buffer is the modified image data in the case that the image data was modified; and
generating the image for display by reading the merged data in the screen buffer.

2. A method according to claim 1, wherein the visual effect is applied to an image by modifying the image data for that image as the image data for that image is written to the screen buffer.

3. A method according to claim 1, comprising:
locking the screen buffer prior to writing data from the foreground buffer and the background buffer to the screen buffer; and
unlocking the screen buffer after the merging of the data in the screen buffer so as to enable the merged data to be read to generate the image for display.

4. A method according to claim 1, comprising repeating the applying a visual effect to at least one of the background image and the foreground image, the merging in the screen buffer, and the generating the image for display by reading the merged data in the screen buffer in the case that the visual effect is or comprises an animation effect.

5. A method according to claim 1, comprising:
allocating a first region of the memory as the background buffer prior to writing background image data to the background buffer;
allocating a second region of the memory as the foreground buffer prior to writing foreground image data to the foreground buffer; and
releasing the first and second regions of memory after the data in the foreground buffer has been merged with the data in the background buffer.

6. A method according to claim 1, wherein the merging the data in the screen buffer comprises alpha compositing the foreground image data and the background image data.

7. A method according to claim 1, comprising writing image data to one or more intermediate buffers of memory, said image data being data for one or more intermediate images that are intermediate the foreground and background, and the merging comprises merging the foreground image data with the background image data and the intermediate image data.

8. A method according to claim 7, comprising applying a visual effect to an intermediate image by modifying the intermediate image data prior to the merging.

9. A computer program comprising instructions such that when the computer program is executed on a computing device, the computing device is arranged to carry out a method of generating an image for display on a display screen, the method comprising:
writing background image data to a background buffer of memory;
writing foreground image data to a foreground buffer of memory;
applying a visual effect to at least one of the background image and the foreground image by modifying the background image data and/or the foreground image data respectively;
merging, in a screen buffer of memory, the foreground image data and the background image data, where the image data for an image that is merged in the screen buffer is the modified image data in the case that the image data was modified; and
generating the image for display by reading the merged data in the screen buffer.

10. A computer program according to claim 9, comprising instructions such that the visual effect is applied to an image by modifying the image data for that image as the image data for that image is written to the screen buffer.

11. A computer program according to claim 9, comprising instructions such that the method comprises:
locking the screen buffer prior to writing data from the foreground buffer and the background buffer to the screen buffer; and
unlocking the screen buffer after the merging of the data in the screen buffer so as to enable the merged data to be read to generate the image for display.

12. A computer program according to claim 9, comprising instructions such that the method comprises repeating the applying a visual effect to at least one of the background image and the foreground image, the merging in the screen buffer, and the generating the image for display by reading the merged data in the screen buffer in the case that the visual effect is or comprises an animation effect.

13. A computer program according to claim 9, comprising instructions such that the method comprises:
allocating a first region of the memory as the background buffer prior to writing background image data to the background buffer;
allocating a second region of the memory as the foreground buffer prior to writing foreground image data to the foreground buffer; and
releasing the first and second regions of memory after the data in the foreground buffer has been merged with the data in the background buffer.

14. A computer program according to claim 9, comprising instructions such that the method comprises:
writing image data to one or more intermediate buffers of memory, said image data being data for one or more intermediate images that are intermediate the foreground and background, and the merging comprises merging the foreground image data with the background image data and the intermediate image data.

15. Apparatus for generating an image for display on a display screen, the apparatus comprising:
a processor and memory,
the processor being constructed and arranged to:
write background image data to a background buffer of memory;
write foreground image data to a foreground buffer of memory;
apply a visual effect to at least one of the background image and the foreground image by modifying the background image data and/or the foreground image data respectively;
merge, in a screen buffer of memory, the foreground image data and the background image data, where the image data for an image that is merged in the screen buffer is the modified image data in the case that the image data was modified; and
generate the image for display by reading the merged data in the screen buffer.
